(19) United States
(12) Patent Application Publication
(10) Pub. No.: US 2004/0215547 A1
(43) Pub. Date: Oct. 28, 2004

(54) Automated liability management and optimization system

(75) Inventors: Amir A. Nazari, Sunnyvale, CA (US); Pejman Makhfi, San Jose, CA (US)

Correspondence Address: BURNS DOANE SWECKER & MATHIS L L P, POST OFFICE BOX 1404, ALEXANDRIA, VA, 22313-1404, US

(73) Assignee: Financial Circuit, Inc., Campbell, CA

(21) Appl. No.: 10/832,739

(22) Filed: Apr. 26, 2004

Related U.S. Application Data
(60) Provisional application No. 60/465,326, filed on Apr. 24, 2003.

(51) Int. Cl. G06F 17/60

(52) U.S. Cl. 705/36

(57) ABSTRACT

A system and method for optimizing the financial needs of a client. The system has a client data input module for processing the financial information of the client. A quote engine of the system contains a plurality of loan options. The system includes an application server for determining the loan options that optimize the financial needs of the client. In this respect, the application server may have an analysis engine that matches the liabilities of the client with the appropriate loan options. Furthermore, the analysis engine may analyze the client's preferences in order to determine the appropriate loan options.

### RELATED APPLICATION

This application claims the benefit of U.S. Provisional Application No. 60/465,326 filed Apr. 24, 2003, the contents of which are incorporated herein by reference.

### BACKGROUND OF THE INVENTION

The “total financial advisor” is one who understands how to generate assets from debt and can help his or her client with debt as well as assets. Most financial professionals and financial institutions manage a client's balance sheet. Yet to best manage a client's finances, a financial professional must look at both sides of the client's balance sheet: assets and liabilities.

Liabilities are a major component of an individual's balance sheet. Understanding how to translate liabilities into assets improves the client's financial outlook and builds the advisor's own business. Although there are a lot of tools for optimization and management of assets, there are no automated, cost effective, and real-time based systems to help with the management and optimization of a client's liabilities.

A financial advisor should have knowledge of mortgages, equity loans, consumer loans, and other types of debt. Furthermore, the advisor must have contact and relationships with many lenders and have access to their lending criteria, guidelines, and rates and be able to transact with them. The advisor should be an expert in debt and liability consolidation and management and understand tax consequences and cash flow issues. Similarly, the advisor should understand the suitability of various debt based on risk, age, life cycle, economic cycle, goals, cash flow needs, etc. to suggest the right options for the client.

Currently, an advisor must have all of the above requirements to evaluate all of the possible options and outcomes using thousands of possible programs from various lenders. The advisor should do all of this analysis and planning in a timely manner as to ensure the programs, rates, guidelines, and criteria do not change and remain valid. Furthermore, the advisor should provide transaction capability to the client to act on the information in a timely manner which can be physically impossible or economically not viable to currently do.

Some financial planning tools are based on “what if” scenario modeling and therefore do not provide a relevant and accurate expectation of the outcome. These tools require an individual to seek out numerous different providers for execution to realize any benefits. Currently, there is no automated solution like this in the market.

### BRIEF SUMMARY OF THE INVENTION

A system for optimizing the financial needs of a client. The system has a client data input module for processing the financial information of the client. A quote engine of the system contains a plurality of loan options. The system includes an application server for determining the loan options from the quote engine that optimize the financial needs of the client. In this respect, the application server may have an analysis engine that matches the liabilities of the client with the appropriate loan options. Furthermore, the analysis engine may analyze the client's preferences in order to determine the appropriate loan options.

The application server is configured to present the loan options to the client for selection. Furthermore, the application server may present secondary services to the client for selection. After the client has selected the appropriate loan option, a transaction engine can process the loan. In order to ensure that the system has the most up-to-date loan options available, the system includes a quote engine that periodically receives loan information. The system may further include a prospector module to identify new business opportunities and a profiler to save the client financial information.

### BRIEF DESCRIPTION OF THE DRAWINGS

These, as well as other features of the present invention, will become more apparent upon reference to the drawings wherein:

FIG. 1 is a flowchart showing the steps an automated liability management and optimization system performs according to the present invention.

FIG. 2 is a flowchart showing operation of the system of the present invention.

FIG. 3 is a detailed block diagram of the system shown in FIG. 2.

FIG. 4 is a block diagram of the analysis engine shown in FIG. 2.

FIG. 5 is a block diagram of the secondary services show in FIG. 2.

FIGS. 6-16 are screen shots generated by the system shown in FIG. 2.

FIG. 17 is a block diagram of the monitoring services shown in FIG. 2.

FIG. 18 is a block diagram of the prospector shown in FIG. 2.

FIG. 19 is a block diagram of the profiler shown in FIG. 2.

### DETAILED DESCRIPTION

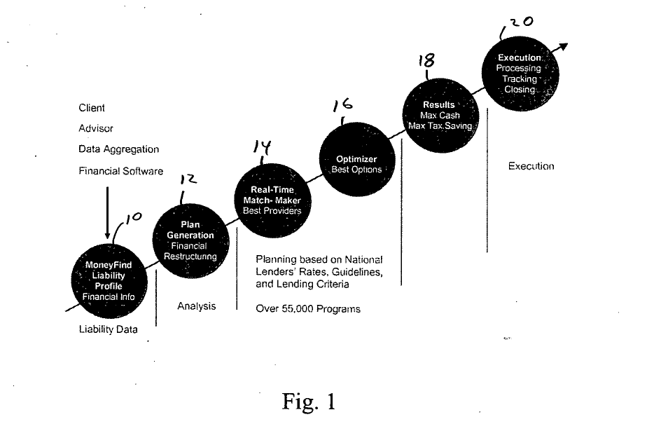

Referring now to the drawings wherein the showings are for purposes of illustrating a preferred embodiment of the present invention only, and not for purposes of limiting the same, FIG. 1 generally illustrates the process of using an automated liability management and optimization system. In step 10, the financial professional enters the client's general information such as contact information, income, liabilities (mortgage, equity loans, car loan, credit cards, etc.), state of residence, tax rate, and other preferences such as risk tolerance, needs, and other critical personal preferences into a user-friendly web interface.

In step 12, the system calculates dozens of suitable scenarios based on the client's financial data to determine how the liabilities can be restructured. For each possible scenario the service evaluates products from many financial institutions in real time by looking at their rates, guidelines, lending criteria, costs, and other critical factors.

In steps 14 and 16, the system matches the best provider and product for each scenario and provides the professional with a few appropriate options that he or she can present to the client. Each plan lists the monthly excess cash savings, potential tax benefits, and discloses details of each plan including rates, costs, suitability and more.

In step 18, the system communicates options and results to the client. The client examines each option and selects the plan that best fits their needs in step 20. Furthermore, the client applies for the desired plan and the processing and closing are tracked and reported in step 20.

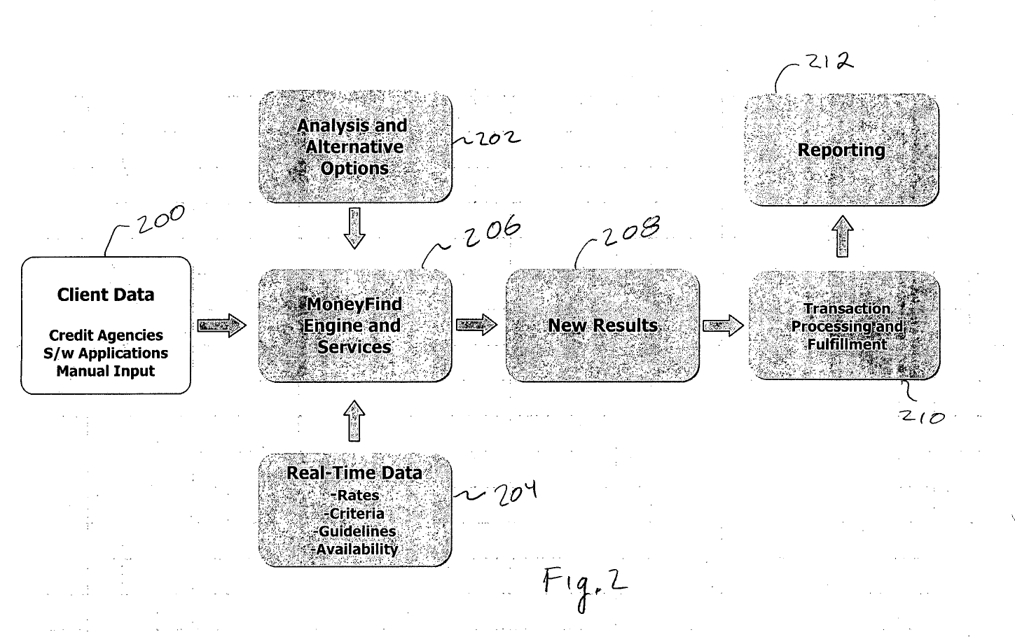

Referring to FIG. 2, a flowchart showing the operation of the automated liability management and optimization system. Specifically, FIG. 2 illustrates that client data 200, analysis and alternative options 202, and real-time data 204 are processed by a software engine 206. The client data 200 that includes financial information, liability information, preferences, etc. can be entered manually or by extracting information from credit reporting agencies, data aggregators, etc., as will be further explained below. The real-time data 204 contains current up-to-date information about loan rates, criteria, guidelines and availability. The analysis and alternative options 202 provide restructuring scenarios and investment opportunities based on the client's data. The software engine 206 generates new results 208 that are communicated to the client. The new results 208 contain real-time information about available loan options that optimize and manage the liabilities of the client and may include investment or 3^{rd} party products. The client has the ability to execute any of the options in the transaction and processing fulfillment step 210. As will be further explained below, the client can use the automated liability management and optimization system to execute one of the selected options from the new results 208. The status of the selected loan(s) is reported to the client and/or the financial advisor in step 212.

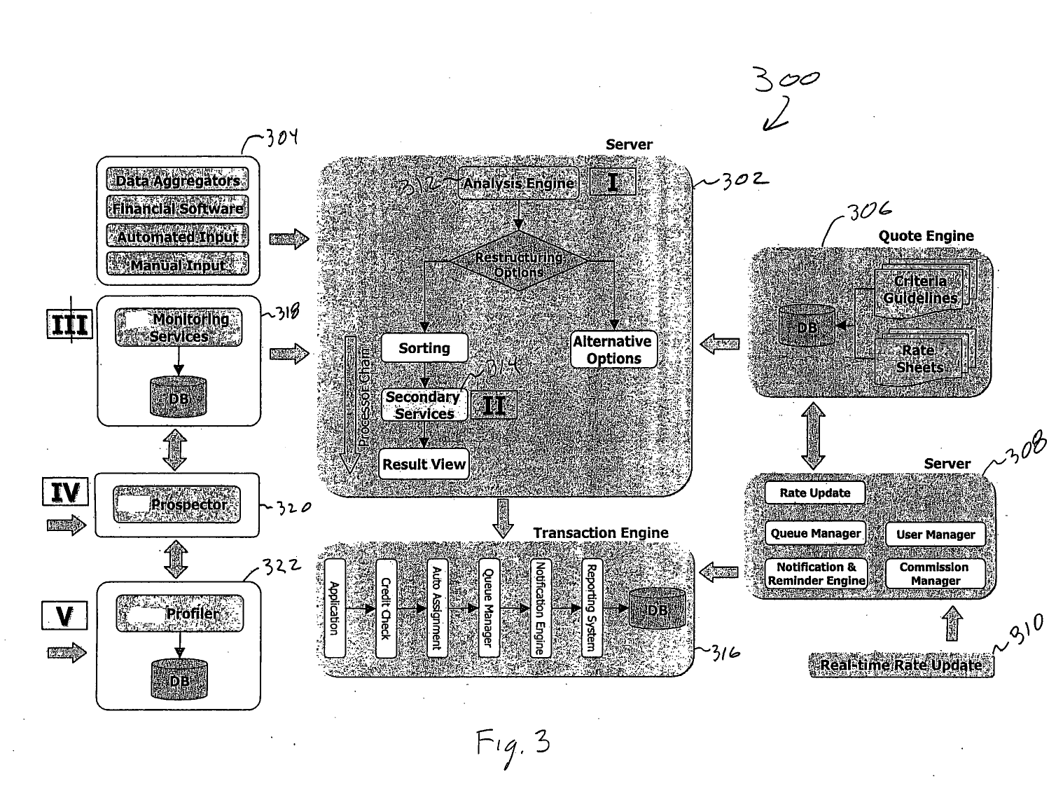

A block diagram of an automated liability management and optimization system 300 is shown in FIG. 3. The system 300 is a web based application that is used by financial advisors (i.e., users) for managing the liabilities of clients. As such, the system 300 may be accessed by any user with a connection to the Internet. It will be recognized that even though the system 300 is being described as a web based application, that it is also possible to implement the system 300 in a stand-alone configuration as long as the application has up-to-date loan information.

The system 300 has an application server 302 which performs matching and optimization operations. The server 302 receives client data from client data input module 304. The client data can be entered manually or automatically. In order to enter the client data automatically, the data may be imported from data aggregators, financial software, credit bureaus, etc. with the client's approval.

To enter the data manually, the financial advisor fills out a simple online form. The form does not have any confidential information about the client. The advisor and client can sit down together and gather the information, or the client can fill-out the information on his own or transmit it through various mediums. Also, the financial advisor can import the information from an existing client database. The profile form takes a snapshot of the client's liabilities such as how much the client owes, and how much the client pays to service those liabilities, etc.

The financial advisor can save the profiles to keep a record of this information for future use. This allows the system 300 and the advisor to save and load profiles as needed and use them to repeatedly find the best possible plans. Furthermore, the save profiles provide a great prospecting tool. Referring to FIG. 3, a profiler 322 saves the clients information. The profiler 322 is shown in FIG. 19 and has a database 330 of client information. Furthermore, the profiler 322 has an import/export handler 326. A profile processor 328 is used with a report generator 340 to generate client information reports. If the financial advisor manually loads the profile, the system 300 will update the profile page with the most recent information.

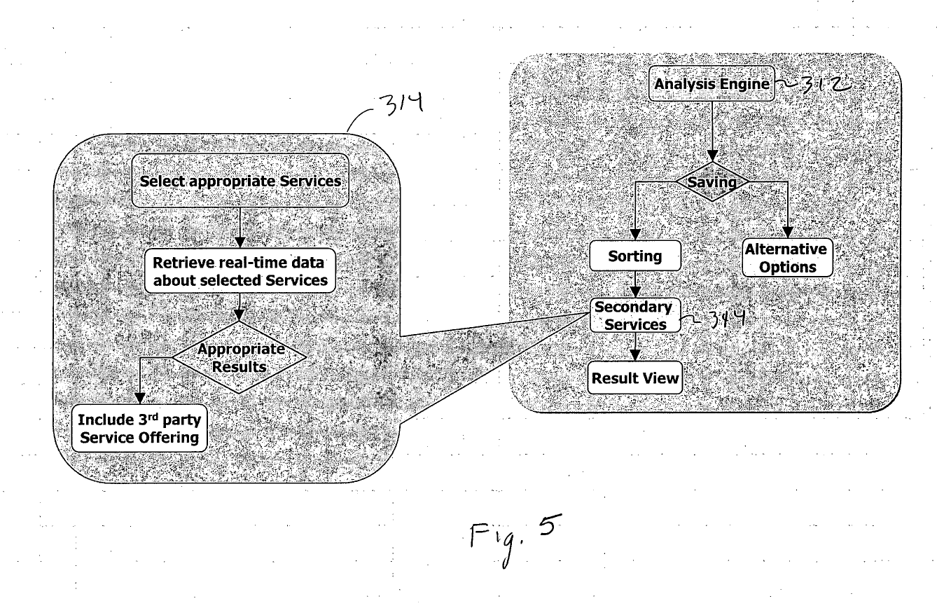

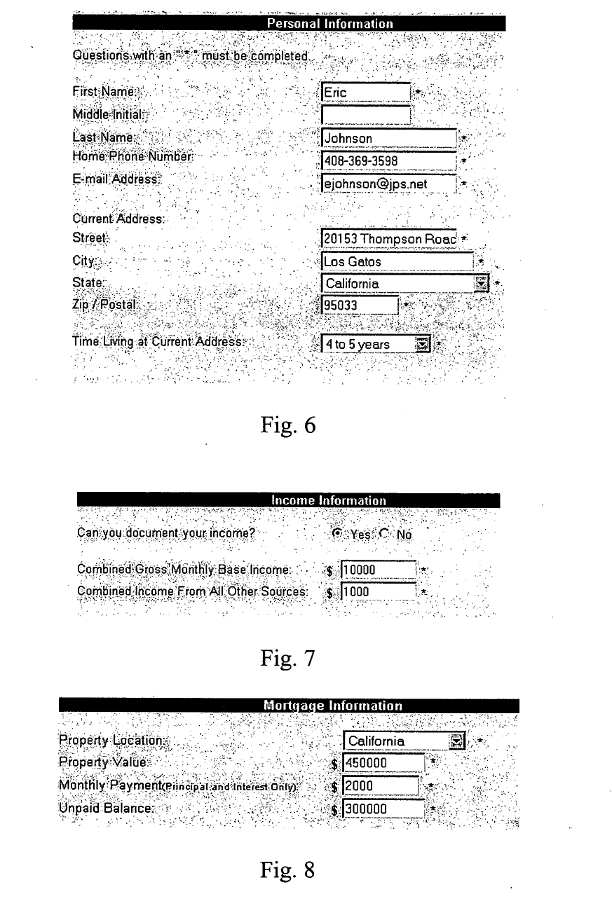

The information entered by the financial advisor includes basic personal information: name, address, and email, as seen in FIG. 6. Although it is basic, this information is important because shows the client that the financial plan was individually created for them.

Referring to FIG. 7, income information, including whether the client can document their income or not (this is a factor in the qualification for mortgages) is entered next.

The third component of information that is entered is the client's liability information. Liabilities are broken into mortgages and all others. Mortgages are a major liability and provide a tax shelter, or have tax consequences, and vary state by state. Referring to FIG. 8, mortgage information is appropriately entered.

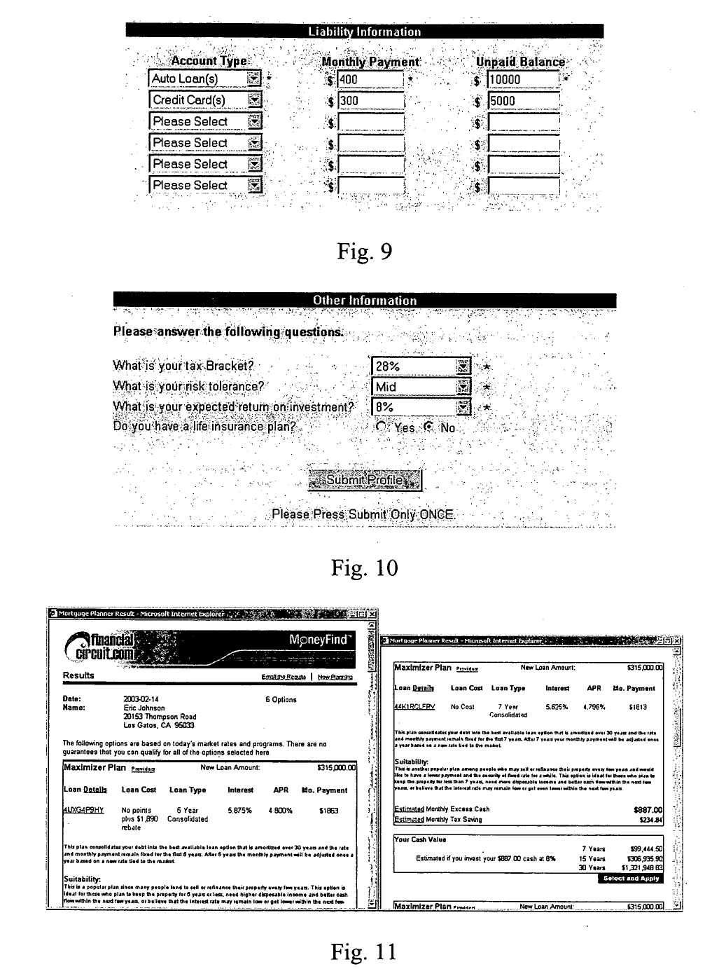

Next, other liabilities such as auto loans, credit cards, second mortgages, student loans, etc. that the client or his family may have are entered. Referring to FIG. 9, the other liability information is entered in the appropriate locations.

Finally, referring to FIG. 10 some customized questions related to the client's existing tax situation, personal preferences, and needs such as risk tolerance, needs, goals, etc. that may vary depending on the environment are asked.

Referring back to FIG. 3, the server 300 also receives data about current loans that are available. In this regard, a quote engine 306 generates a database of loans. The quote engine 306 has criteria guidelines and rate sheets for the loans available. In order to have the most up-to-date information about available loans, real-time-updates 310 are uploaded to a management server 308 that then updates the quote engine 306.

As previously mentioned above, the server 302 matches the liabilities of the client with appropriate loan options. The server 302 has an analysis engine 312 that matches the appropriate loan to the liabilities of the client. Referring to FIG. 4, the analysis engine 312 uses the systems liability management logic and analyzes the client's data, needs, and preferences such as risk factors, life style, goal vs. cash requirements, and other critical elements such as economic factors to create viable options. These options are compared to the criteria of the available loans generated by the quote engine 306 in order to calculate the coverable debt and generate new results in an iterative process.

Specifically, the profile information is transmitted from the input module 304 to the server 302 where real-time analysis is performed on the data, and the liability portfolio is restructured in many different ways. This is accomplished using a matching algorithm and process based on experience working with clients and understanding how they can benefit from consolidations and various options.

For every one of the restructuring scenarios generated, the system 300 contacts the banks for their criteria, guidelines, and rates in real-time with the quote engine 306. The system 300 finds programs and lenders that fit each scenario that can service the debt. The system 300 does the same for all scenarios creating unique restructuring options based on market data.

Among the programs searched, the system 300 identifies the providers and programs that meet the personal preferences of the client and offer the best rates, lowest payment, no prepayment penalties and have a good score card or rating. The system 300 selects options that meet the client's goals and preferences in the order that produces the highest cash and tax savings and then publishes the results.

Needless to say, to select the appropriate options without automated software, a client needs to have a financial advisor who is familiar with hundreds of banks, mortgages, taxes, consolidation, and can do the research to create these plans. The entire process would take about a week for an individual advisor. Because there are thousands of scenarios, various ways of consolidating, numerous banks, different rates, and variables, by the time the advisor finished, all of the information would be obsolete and prohibitively expensive to the client.

However, the system 300 performs this work in a matter of seconds. The profile information is analyzed, plans are generated, lenders are identified and selected, the restructuring plans are optimized, and finally published for review and execution.

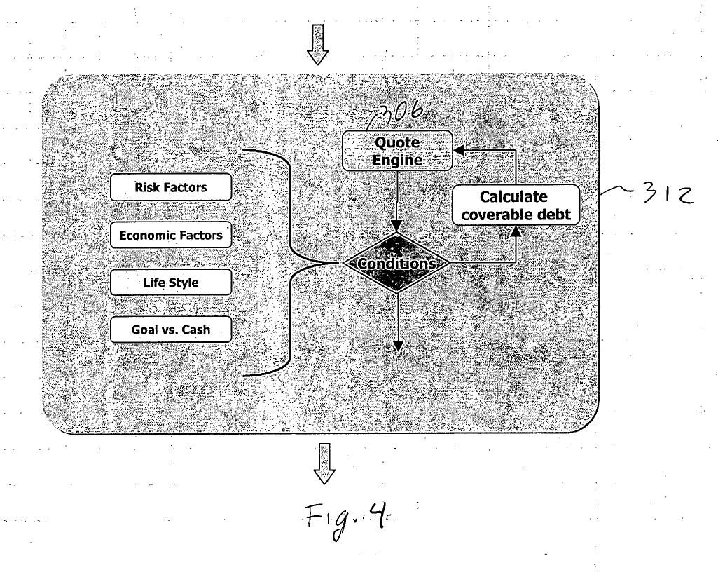

Referring to FIG. 3, the analysis engine 312 generates a list of the available restructuring options available to the client. The server 302 sorts the restructuring options and then inserts secondary services 314 into the sorted list of options available to the client. Referring to FIG. 5, the secondary services are complimentary products and services offered by partners, customers, or 3^{rd} party providers. A profile manager and user manager will define the secondary services and their use in the results. These services may include, but are not limited to, products such as insurance, retirement plans, saving plans, college saving plans, asset and liability related products. It also includes products such as illustration, risk analysis, etc.

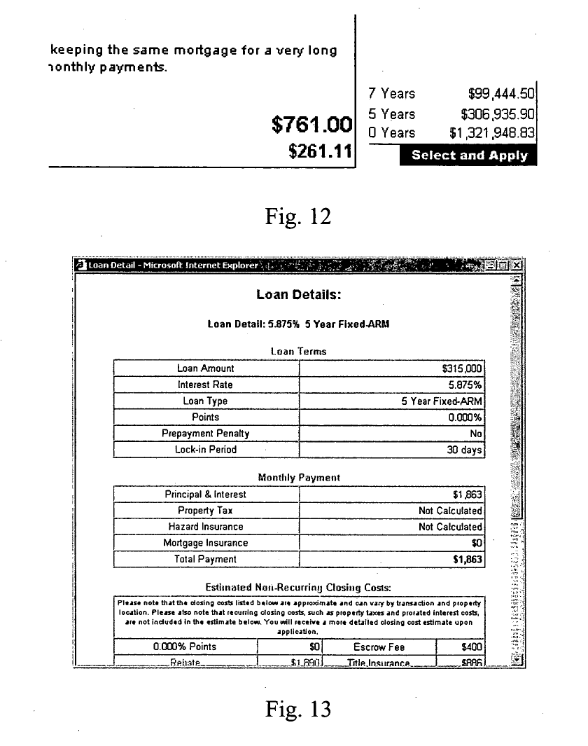

Once, the plans have been generated, the results are presented to the client and/or financial advisor via different mediums. Referring to FIGS. 11 and 12, published plans include date, time sensitive material, and the client's name and address for identification. Furthermore, the number of plans, appropriate instructions, and disclaimers are published.

For each plan, the system 300 provides a secure and encrypted online application along with comprehensive information that includes:

Instructions and help;

Assumptions and disclaimers;

Amount in excess monthly and yearly cash;

Amount in excess monthly and yearly tax benefits;

Summary description of the loan type, rates, payments, and costs;

Description of the destructing option and the plan;

Description of the suitability of the plan for the client;

List of providers or programs behind the plan;

Illustrations of the plan benefits;

Benefit of the plan based on preference data;

Information and illustrations for the secondary services; and

Other information based on the client preferences.

Additionally, further loan information is disclosed under details. However, final details about the loan will be provided when the client is ready to go forward with the plan. Referring to FIG. 13, the preliminary loan information may include:

Preliminary good faith estimate for the plan or loan;

Detailed list of costs if any;

Locking period;

Payment and interests;

Rates and APR information; and

Other information as required by the client or Equal Opportunity Lending requirements.

Financial advisors can leave the decision making to their client by sending the plan results to their client via an integrated web based email notification from the system 300, or by printing the plan and then faxing and/or mailing it.

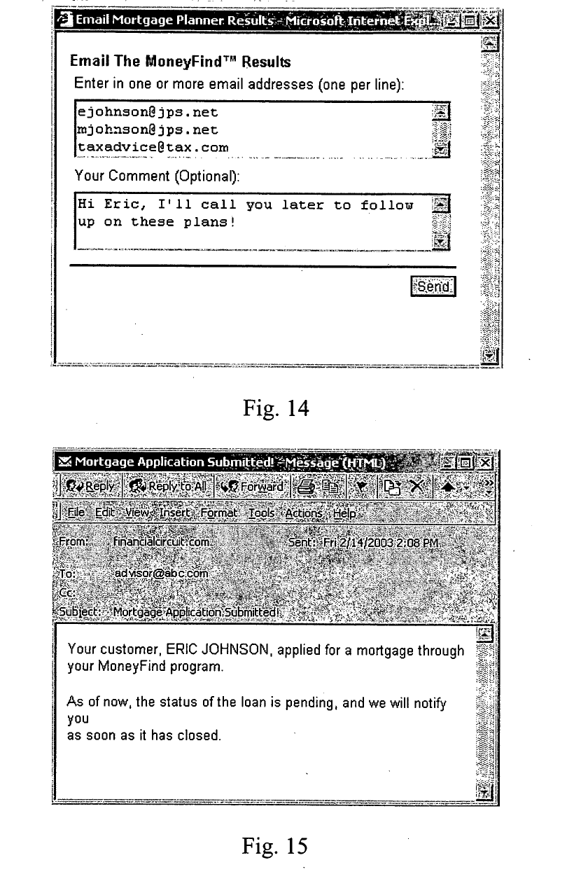

Referring to FIG. 14, if email is used, a window containing client email information and messaging capability is provided. The advisor can include the client's tax attorney, spouse, and others to the notification list and customize the message or provide comments for the client. Accordingly, the advisor does not need to use a separate email system. An email server of the system 300 provides the plan and tracking information as needed. (FIG. 15). The entire plan is sent to the client in a format suitable for the client so that he or she can review and act on the information from within the email.

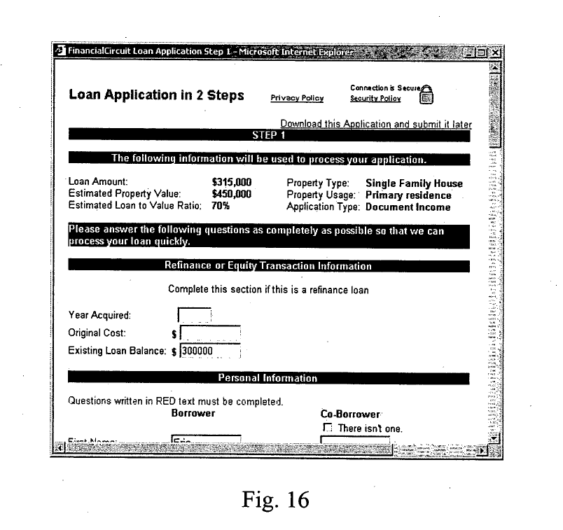

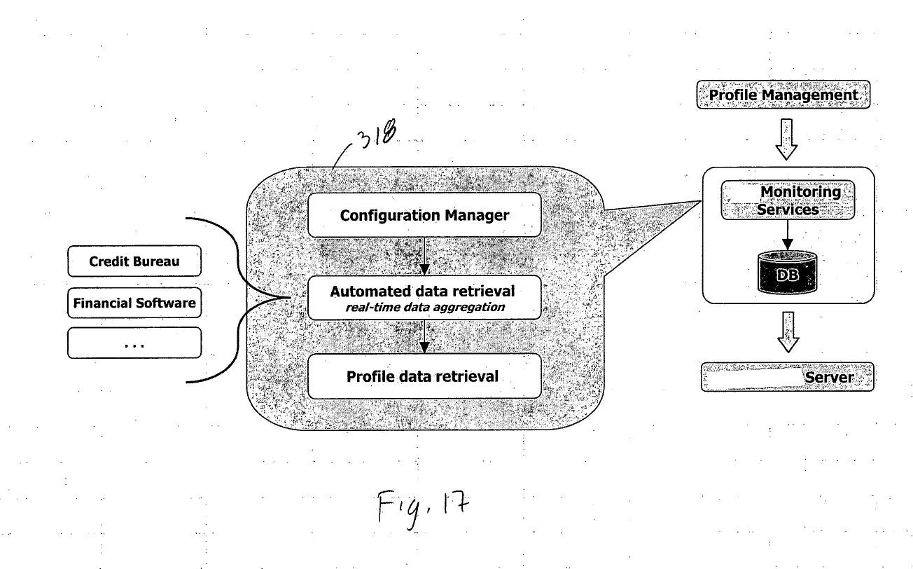

Once a plan is selected, a client can simply select apply. At this point, a secure, encrypted and compliant application (with all of the privacy and security policies disclosed) will be presented on the Web. (FIG. 16). The application includes pre-filled information about the client. The client can input the remaining required information such as: social security number, account information, etc. The client can submit the application online or contact the appropriate people for execution.

Referring to FIG. 3, once the application is submitted, it is transmitted to the server 302 and a transaction engine 316 starts the processing, notifications, and tracking of the application until the transaction is completed. Specifically, the transaction engine 316 will perform a credit check and report the progress of the loan to the client and/or financial advisor.

As soon as the client submits the application, the advisor will get an email notification informing him that their client has decided to pursue one of the financial plans. (FIG. 15). The advisor is involved in the process until the loan is closed. Once the funds become available to the client, the advisor receives another email notifying them that funds are now in the hands of the client. The transaction engine 316 can be an application associated with the system 300 or provided by an outside provider not associated with the system 300. In this regard, loan processing may be independent of the system 300.

In addition to the foregoing, the system 300 of the present invention provides liability and debt monitoring services 318 that allow the system 300 to act based on predefined conditions such as rules, events, periods, etc. The monitoring service 318 determines when an event occurs such as a client buys a house, makes a large purchase on credit, reaches a certain age or a certain liability thresh hold, or when the market rates changes, etc. Any of these conditions can activate the system to notify the financial advisor. This provides the financial advisor the opportunity to contact the client to see if the client wishes to use the service of the system 300. The conditions for which the financial advisor or the client are contacted by the monitoring service 318 can be set in the user manager and the profile manager based on the user and client's preferences. Furthermore, the monitoring services can be used with other services.

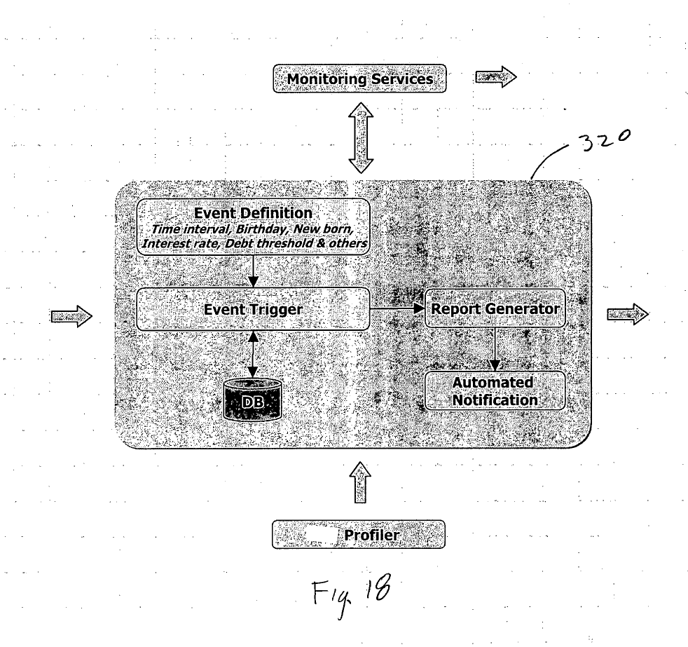

Referring to FIG. 17, automated data retrieval from credit bureaus, financial software, etc. can be used to determine when a predefined event happens and/or after a predefined event is detected. When the system 300 is used with monitoring services 318 and automated update services, the system 300 provides a complete automation and management of debt and liabilities. The automatic update service automatically retrieves and updates client data with profile information from credit bureaus and agencies, financial applications, and/or databases based on the clients preferences. The update service can automatically detect events, and act on those events, and notify the user or the client.

The system 300 further includes a prospector 320 that allows the user (i.e., financial advisor) to run the system 300 on all or selected clients based on the user preferences. The prospector 320 is a productivity-enhancing tool for the user that identifies new business and liability restructuring. Furthermore, the prospector 320 can identify new opportunities and organize the opportunities in the order of priorities defined by the user.

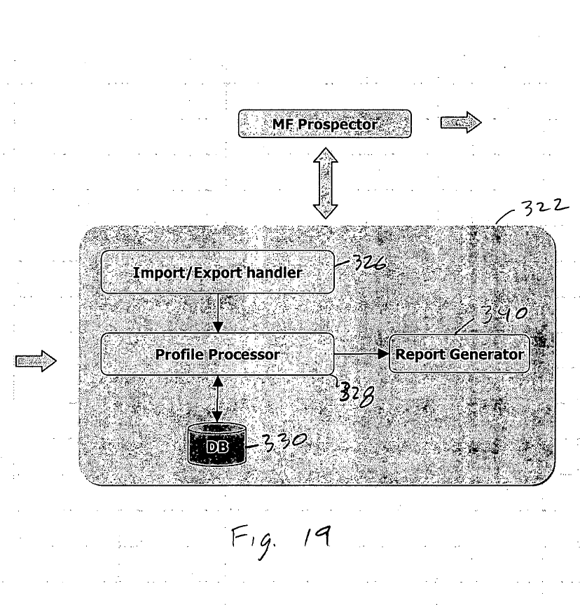

Referring to FIG. 18, the prospector 320 provides the user with a result that includes a summary for each client. The results from the prospector 320 can be organized according to user preferences. For example, the prospector 320 can show the client summary results in the order of highest cash flow generated, cash or savings, etc. The results from the prospector 320 allow the financial advisor to select any summary results and see the details. It allows the user to select and send results to all or selected clients at the same time via email and with a customized message.

As previously described, the automated liability management and optimization system provides:

Analysis, planning, and execution in one place in real-time;

Operation and information based on real-time market data;

Automated processes and results in minutes as opposed to hours or days;

Independence with a large selection of integrated providers;

Post transaction tracking and information for advisor and the client;

Comprehensive up-to-date information such as suitability, costs, and details;

Web based 24/7 access from anywhere at any time through secure access; and

Proactive liability evaluation and optimization based on pre-defined events.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A system for optimizing the financial needs of a client, comprising:
a client data input module for processing client financial information;
a quote engine containing a plurality of loan options; and
an application server for determining the loan options from the quote engine that optimize the financial needs of the client based on the client financial information from the client data input module.

2. The system of claim 1 wherein the application server comprises an analysis engine that matches the liabilities of the client from the client financial information with appropriate loan options from the quote engine.

3. The system of claim 2 wherein the analysis engine is configured to analyze clients preferences from the client financial information in order to determine the loan options.

4. The system of claim 1 wherein the application server is configured to present the loan options to the client.

5. The system of claim 4 wherein the application server is configured to present secondary services to the client.

6. The system of claim 1 further comprising a transaction engine for processing a loan option selected by the client.

7. The system of claim 1 further comprising a management server to provide up-to-date loan options to the quote engine.

8. The system of claim 1 further comprising a prospector module to identify new business opportunities.

9. The system of claim 1 further comprising a profiler to save the client financial information.

10. A method for optimizing the financial needs of a client, the method comprising the following steps:
processing financial information of the client with a client data input module;
generating a plurality of loan options with a quote engine; and
matching with an application server the loan options from the quote engine to the financial needs of the client with the client financial information in order to optimize the client's financial needs.

11. The method of claim 10 wherein the application server matches with an analysis engine the liabilities of the client obtained from the client financial information to appropriate loan options.

12. The method of claim 11 further comprising the step of analyzing preferences of the client from the client financial information in order to match the loan options with the analysis engine.

13. The method of claim 10 further comprising the step of presenting the loan options to the client with the application server.

14. The method of claim 10 further comprising the step of presenting secondary services to the client with the application server.

15. The method of claim 10 further comprising the step of processing the loan option selected by the client with a transaction engine.

16. The method of claim 10 further comprising the step of providing up-to-date loan options to the quote engine with a management server.

17. The method of claim 10 further comprising the step of identifying new business opportunities with a prospector module.

18. The method of claim 10 further comprising the step of saving the client information with a profiler.

19. A system for optimizing the financial needs of a client, the system comprising:
input means for obtaining financial information of the client;
loan information means for obtaining up-to-date loan options;
matching means for determining loan options that optimize the financial needs of the client based on the financial information of the client.

20. The system of claim 19 wherein the input means is a client data input module, the loan information means is a quote engine containing a plurality of loan options, and the matching means is an application server for determining the loan options that optimize the financial needs of the client.
